(19) United States
(12) Patent Application Publication
(10) Pub. No.: US 2020/0380545 A1
(43) Pub. Date: Dec. 3, 2020

(54) PRESENTING PRODUCTS TO USERS BASED ON PERSONALIZED PRODUCT PRICING DETERMINED FROM USER CHARACTERISTICS

(71) Applicant: Or Ein Sof Incorporated, Wilmington, DE (US)

(72) Inventors: Roman Sandler, Los Angeles, CA (US); David Heller, Oakland, CA (US); Marcie Ann Cooperman, Scottsdale, AZ (US); Richard Andrew Komaiko, Scottsdale, AZ (US)

(21) Appl. No.: 16/887,166

(22) Filed: May 29, 2020

Related U.S. Application Data
(60) Provisional application No. 62/854,392, filed on May 30, 2019.

(51) Int. Cl. G06Q 30/02; G06K 9/62; G06N 3/04

(52) U.S. Cl. CPC G06Q 30/0206; G06N 3/0454; G06K 9/6256; G06Q 30/0283

(57) ABSTRACT

A merchant system offers various products for sale to users, with prices for different products received from a pricing server. The merchant system provides information identifying a user to a pricing server, which determines user-specific prices for the products offered by the merchant system. Prior purchases of products by various users via the merchant system and user-specific information maintained by the pricing server for the user corresponding to the user identifying information are used to generate the user-specific prices. The pricing server selects the user-specific price for a product as a candidate price having a maximum expected profit to the merchant system. Subsequently, the pricing server transmits to the merchant system a listing of products offered by the merchant system and their user-specific prices ordered by their expected profit to the merchant system. The merchant system displays the products to the user in the order received from the pricing server.

### CROSS-REFERENCE TO RELATED APPLICATIONS

This application claims the benefit of U.S. Provisional Application No. 62/854,392, filed May 30, 2019, which is incorporated by reference in its entirety.

### SUMMARY

This application relates generally to determining pricing and presentation of products, and more specifically to accounting for prior purchases of products by a user to determine personalized pricing of products for the user.

A merchant system offers various products for sale to users. For example, the merchant system presents information describing different goods or services to users and receives selections of goods or services from users. The merchant system receives payment from a user for products, such as goods or services, selected by the user and provides the products to the user after receiving payment.

Conventional merchant systems determine prices for products based on a cost of a merchant system to obtain a product. For example, a merchant system increases a sum of a wholesale price of a product for the merchant system and costs incurred by the merchant system to store and to physically obtain the product by a specific percentage or amount to determine the price of the product. While this allows a merchant system to price products so the merchant system makes a particular profit when selling a product, this pricing determination does not account for responsiveness of individual users to prices specified by the merchant system.

Additionally, when a user accesses a merchant system, the merchant system displays products to the user in a static order. Hence, multiple users are presented with products in a common order. While this common presentation of products simplifies configuration by the merchant system, presenting products in a common order and common presentation increases a difficulty of specific users identifying products that the specific users are more likely to purchase. As users increasingly access merchant systems via mobile devices or other devices with limited display areas, users are less likely to navigate through large numbers of products organized and displayed by the merchant system in a fixed order for multiple users to identify and select certain products.

### SUMMARY

A merchant system offers various products for sale to different users, with prices for different products received from a pricing server. In various embodiments, the merchant system receives user identifying information from a user accessing the merchant system and provides the user identifying information to the pricing server. Based on prior purchases of products by various users via the merchant system and user-specific information maintained by the pricing server for the user corresponding to the user identifying information, the pricing system generates user-specific prices for products offered by the merchant system. Examples of user-specific information used by the pricing server include the user's location, age, sex, prior purchases from the merchant system, prior interactions with offers for alternative product prices by the merchant system, as well as a type or operating system of a client device used by the user to access the merchant system. When generating a user-specific price for a product, the pricing server determines expected profit to the merchant system for different prices based on the likelihood of the user purchasing the product when offered at different candidate prices and a cost of the product to the merchant system. The pricing server selects the user-specific price for the product as a candidate price having a maximum expected profit to the merchant system. Subsequently, the pricing server transmits a listing of products offered by the merchant system ordered by their expected profit to the merchant system and corresponding user-specific prices to the merchant system. The merchant system displays the products to the user in the order specified by the listing received from the pricing server rather than in an order maintained by the merchant system.

### BRIEF DESCRIPTION OF THE DRAWINGS

FIG. 1 is a block diagram of a system environment in which a pricing server operates, in accordance with an embodiment.

FIG. 2 is a block diagram of a pricing server, in accordance with an embodiment.

FIG. 3 is an interaction diagram of a method for determining an order in which a merchant system presents products to a user based on user-specific prices determined for the user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

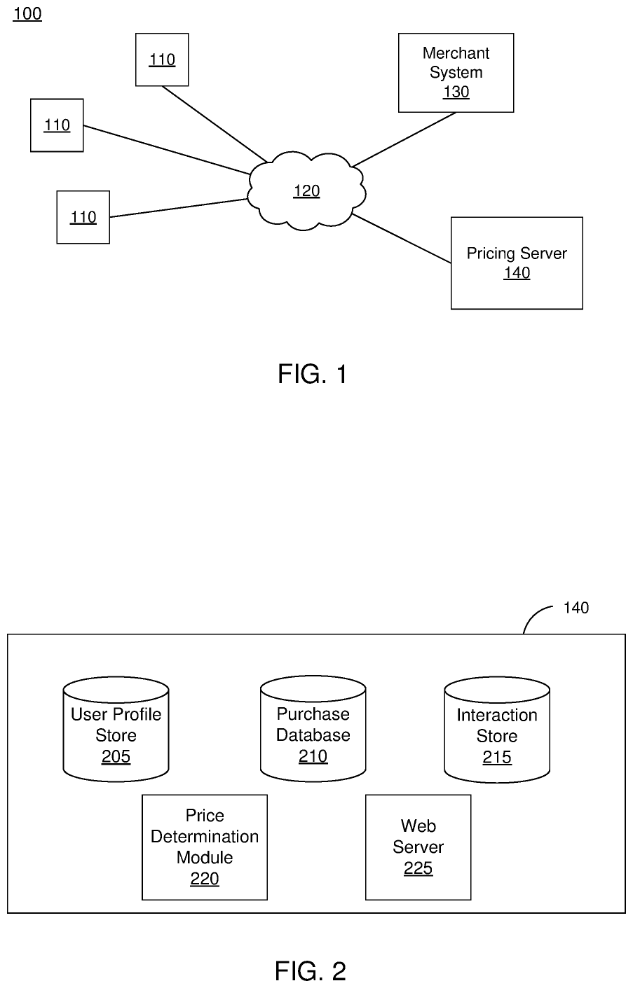

FIG. 1 is a block diagram of a system environment 100 for a pricing server 140. The system environment 100 shown by FIG. 1 comprises one or more client devices 110, a network 120, a merchant system 130, and the pricing server 140. In alternative configurations, different or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the merchant system 130, or other third party systems. For example, a client device 110 executes a browser application to enable interaction between the client device 110 and the merchant system 130 via the network 120. In another embodiment, a client device 110 interacts with the merchant system 130 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more merchant systems 130 may be coupled to the network 120 for communicating with the pricing server 140, which is further described below in conjunction with FIG. 2, and with a client device 110. While FIG. 1 shows a single merchant system 130 for purposes of illustration, in other embodiments, any number of merchant systems 130 may be coupled to the network 120. A merchant system 130 maintains information describing one or more products (e.g., goods or services) offered for purchase via the merchant system 130. In various embodiments, client devices 110 obtain the descriptions of one or more products from the merchant system 130 and present the obtained descriptions to users. Additionally, the merchant system 130 associates prices with different products. For example, the merchant system 130 associates a monetary amount with a product that is presented to a user in conjunction with a description of the product. Using a client device 110 a user selects one or more products offered by the merchant system 130 from descriptions of one or more products the client device 110 obtains from the merchant system 130 and provides the merchant system 130 with an amount of compensation based on the prices of the selected one or more products. In response to receiving the amount of compensation, the merchant system 130 provides the selected one or more products to the user.

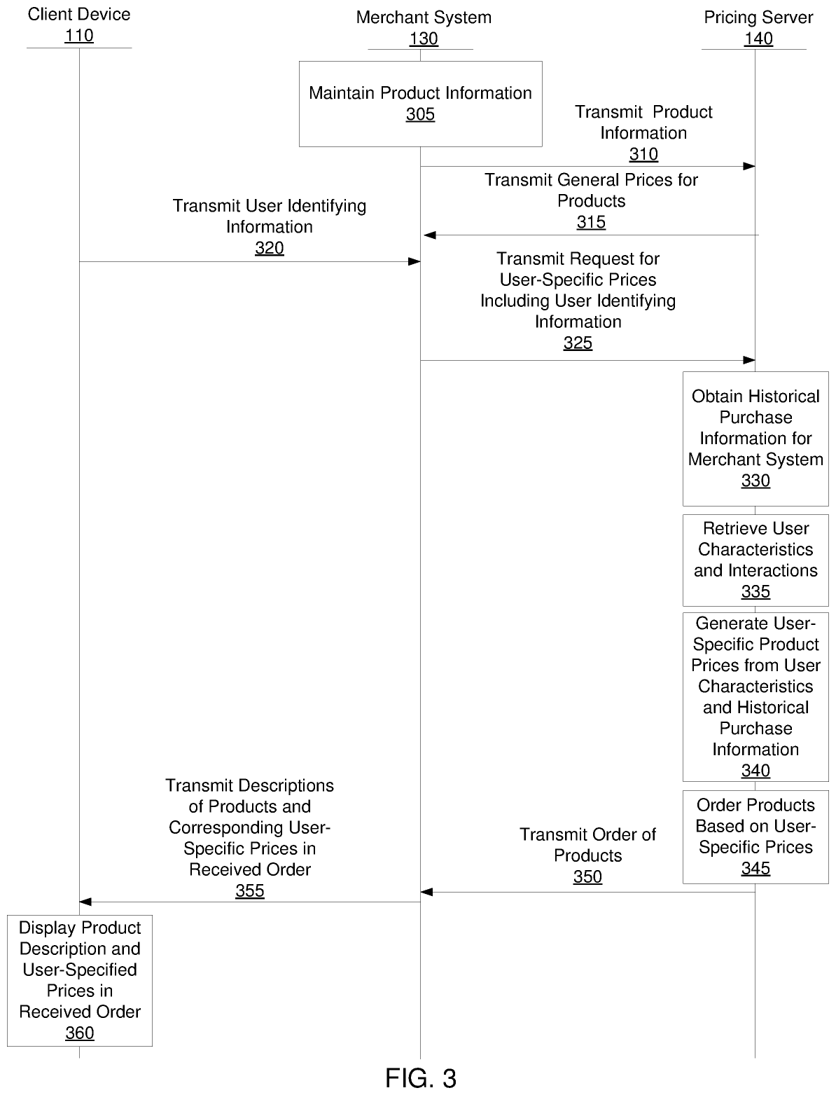

In various embodiments, the merchant system 130 obtains prices for products offered by the merchant system 130 from the pricing server 140, as further described below in conjunction with FIG. 3. For example, the merchant system 130 transmits descriptions of products offered by the merchant system 130 to the pricing server 140, which determines a price for each product that is transmitted to the merchant system 130. As further described below in conjunction with FIGS. 2 and 3, the merchant system 130 may provide information about prior purchase of various products to the pricing server 140, which accounts for prior purchase information of various products when determining prices for different products.

The pricing server 140, further described below in conjunction with FIG. 2, determines prices for products offered by the merchant system 130 and transmits the determined prices to the merchant system 130. In various embodiments, the pricing server 140 transmits a price associated with an identifier or a description of a product corresponding to the price. When determining a price for a product offered by the merchant system, the pricing server 140 determines a general price for the product and a user-specific price for the product in various embodiments. The general price is determined by the pricing server 140 from a cost of the merchant system 130 to obtain the product (e.g., a wholesale price of the product for the merchant system 130 and costs incurred by the merchant system 130 to store and to physically obtain the product), without information about a user accessing the merchant system 130. For example, the pricing server 140 determines the general price for the product based application of one or more trained models to the cost of the merchant system 130 to obtain the product that determine a general price for the product that maximizes a profit to the merchant system 130 when the product is sold. For example, based on prior purchases of a product via the merchant system 130 by users within a time interval and prices at which the merchant system offered the product via the merchant system 130, the pricing server 140 determines a likelihood of users purchasing the product when offered at different prices 130. As further described below in conjunction with FIGS. 2 and 3, the pricing server 140 determines an expected profit to the merchant system 130 for offering the product at different prices based on the likelihood of users purchasing the product at various prices and differences between each of the various prices and a cost to the merchant system 130 to obtain the product. The pricing server 140 determines the general price for the product as the price having a maximum expected profit to the merchant system 130. Thus, the pricing server 140 leverages global information from the merchant system 130 describing purchases of products and prices at which the products were offered to determine a general prize for a product.

As further described below in conjunction with FIGS. 2 and 3, the pricing server 140 also determines a user-specific price for one or more products offered by the merchant system 130. The user-specific price for a product is based on characteristics of a user maintained by the pricing server 140 and prior purchases of the product by other users of the merchant system 130. For example, the merchant system 130 provides the pricing server 140 with information describing prior purchases of products via the merchant system 130. In various embodiments, the merchant system 130 provides a number of visits to the merchant site 130 by users during a particular time interval and a number of purchases of each of at least a set of products offered by the merchant system 130 during the particular time interval.

Additionally, the pricing server 140 may receive information from the merchant system 130 identifying a user accessing the merchant system 130 and retrieve one or more stored characteristics of a user corresponding to the user identifying information. The pricing server 140 applies a trained machine learning model to the stored characteristics of the user corresponding to the user identifying information and to the information describing prior purchases of products from the merchant system 130 to determine user-specific prices for one or more products offered by the merchant system 130.

The pricing server 140 trains the machine learning model from prices at which products was previously purchased by the merchant system 130 and characteristics of users who previously purchased the products via the merchant system 130 and may account for other types of interactions by the users with the merchant system 130. The pricing server 140 trains the machine learning model to determine a likelihood of a user purchasing a product when the product is offered at a particular price. For example, the pricing server 140 applies a label indicating a product was previously purchased from the merchant system to a price of the product, characteristics of users who purchased the product, and characteristics of the product. From the labeled price, characteristics of the user, and characteristics of the product, the pricing server 130 trains the machine learning model using any suitable training method or combination of training methods (e.g., back propagation to train the machine learning model if it is a neural network, curve fitting techniques if the identification model is a linear regression). After training, the pricing server 140 applies the trained machine learning model to characteristics of a product, to characteristics of a user, and to a price of the product and the machine learning model outputs a probability of the user purchasing the product at the price.

When determining a user-specific price for a product, the machine learning model applied by the pricing server 140 determines a likelihood of the user purchasing the product for different prices of the product, and selects the user-specific price for the product as a price of the product providing a maximum expected profit to the merchant system 130, with the expected profit to the merchant system 130 for a price determined as a product of the likelihood of the user purchasing the product offered at the price and a difference between the price and a cost of the merchant system 130 to obtain the product (e.g., a wholesale price of the product for the merchant system 130 and costs incurred by the merchant system 130 to store and to physically obtain the product). Determination of user-specific prices for products offered by the merchant system 130 is further described below in conjunction with FIGS. 2 and 3.

FIG. 2 is a block diagram of an architecture of the pricing server 140. The pricing server 140 shown in FIG. 2 includes a user profile store 205, a purchase database 210, an interaction store 215, a price determination module 220, and a web server 225. In other embodiments, the pricing server 140 may include additional, fewer, or different components for various applications. Conventional components such as network interfaces, security functions, load balancers, failover servers, management and network operations consoles, and the like are not shown so as to not obscure the details of the system architecture.

The pricing server 140 maintains a user profile for each user of the pricing server 140 that is stored in the user profile store 205. A user profile may include declarative information about the user that was explicitly shared by the user and may also include information identifying actions performed by the user with the merchant system 130 identified to the pricing server 140. In one embodiment, a user profile includes an identifier of a user and multiple data fields, each describing one or more attributes of the corresponding user. Examples of information stored in a user profile include biographic, demographic, and other types of descriptive information, such as an age, a sex, a language, and a location of the user. Additionally, a user profile may include information identifying a client device 110 used by the user to access the merchant system 130. For example, the user profile includes a device identifier for one or more client devices 110 associated with the user and associates characteristics of a client device 110 with a corresponding device identifier. Example characteristics of a client device 110 include a client device type (e.g., a manufacturer and model), an operating system of the client device 110, dimensions of a display area of the client device 110, or any other suitable information.

A user profile maintained for a user may include a current location of the user and one or more historical locations of the user. In some embodiments, the pricing server 140 receives information identifying the user from the merchant system 130 that includes a location of a client device 110 from which the user accessed the merchant system 130. The merchant system 130 may obtain geographic coordinates of a physical location of the client device 110 if the user authorizes the merchant system 130 to access location information of the client device 110. Alternatively, the merchant system 130 includes a network address (e.g., an Internet Protocol address) of the client device 110 in the information identifying the user provided to the pricing server 140, which determines a physical location of the client device 110 from the network address. In various embodiments, the user profile for a user includes one or more physical locations previously received in association with the user identifier, allowing the user profile to maintain a record of prior physical locations from which the user accessed the merchant system 130. The user profile may include a threshold number of prior physical locations or physical locations from which the user accessed the merchant system 130 within a threshold amount of time from a current time.

Additionally, the user profile for a user may identify interactions by the user with the merchant system 130. For example, after providing user identifying information to the merchant system 130, the merchant system 130 transmits descriptions of one or more interactions with content presented by the merchant system 130 to the pricing server along with an identifier of the user performing the one or more interactions. In various embodiments, the merchant system 130 transmits a description of an interaction where a user selected content presented by the merchant system 130 offering a discounted price for a product or products along with an identifier of the user to the pricing sever 140, which stores the description of the interaction in a user profile for the user. Similarly, the merchant system 130 may transmit an indication that an offer for a discounted price on one or more products was presented to a user along with an identifier of the user and a time when the offer was presented to the pricing server 140, which stores a description of the presented offer and the time when the offer was presented in the user profile of the user. In the preceding examples, the pricing server 140 may determine a ratio of a number of times when the user selected offers for discounted prices that were presented to a user to a number of times when offers for discounted prices were presented to the user via the merchant system 130.

The purchase database 210 includes information describing purchases of products offered by the merchant system 130 over time. In various embodiments, when users access or visit the merchant system 130, the merchant system 130 stores identifying the users who accessed or visited the merchant system 130 and an inventory of products offered by the merchant system 130 when the users accessed or visited the merchant system 130. When a user accessing or visiting the merchant system 130 purchases one or more products, the merchant system 130 also stores information identifying the one or more products purchased by the user. The merchant system 130 transmits information identifying visits or accesses to the merchant system 130 by users, products available for purchase by the merchant system 130 when users visited or accessed the merchant system 130, and products purchased by users who visited or accessed the merchant system 130 to the pricing server 130, which stores the information describing user visits or accesses to the merchant system 130 and products purchased by users visiting or accessing the merchant system 130 in the purchase database 210 in association with an identifier of the merchant system 130. In various embodiments, the pricing server 140 obtains information from the merchant system 130 at a periodic time interval. Alternatively, the pricing server 140 receives information from the merchant system 130 in response to the merchant system 130 receiving a request from the pricing server 140. Hence, the purchase database 130 maintains information for a merchant system 130 identifying products purchased by various users via the merchant system 130, allowing the pricing server 140 to maintain information describing prior purchases of products by users via the merchant system 130 and prior visits or accesses of the merchant system 130 by users.

Additionally, the purchase database 210 includes an inventory of products offered by the merchant system 130. For each product offered by the merchant system 130, the inventory includes an identifier of a product and a cost to the merchant system 130 to obtain the product (e.g., a wholesale price of the product for the merchant system 130 and costs incurred by the merchant system 130 to store and to physically obtain the product), as well as a quantity of the product the merchant system 130 has in stock for purchase. The merchant system 130 may periodically provide the pricing server 140 with quantities of different products that the merchant system 130 has in stock, or the merchant system 130 may provide the pricing server 140 with updated quantities of products that the merchant system 130 has in stock after each sale of a product or when the merchant system 130 receives products. In some embodiments, the inventory also includes a description corresponding to each product offered by the merchant system 130. The description corresponding to a product includes one or more features of the product specified by the merchant system 130 and a category associated with the product by the merchant system. In some embodiments, the description corresponding to the product includes images and text displayed by the merchant system 130 to market or to offer the product.

The price determination module 220 retrieves information from a user profile maintained by the user profile store 205 for a user and from prior purchases of products from the merchant system 130 maintained by the purchase database 210 and trains one or more machine learning models to generate user-specific prices for various products offered by the merchant system 130. This allows the pricing server 130 to determine a price for a product offered by the merchant system 130 that is individualized for a specific user based on prior purchases of the product, and other products, by users of the merchant system 130 and characteristics of the specific user from a user profile maintained by the pricing server 140 for the specific user.

When determining a user-specific price for a product, the price determination module 220 obtains prices for the product when the product was previously purchased by one or more users via the merchant system 130 from purchase database 210. From the obtained prices at which the product was previously purchased, the price determination module 220, determines likelihoods of the user purchasing the product when different prices are associated with the product. In various embodiments, for each price at which the merchant system 130 offered the product, the price determination module 220 determines a ratio of a number of times the product was purchased when offered at a price to a number of times users visited or accessed the merchant system 130 when the product was offered at the price. Additionally, the price determination module 220 retrieves characteristics of the user from the user profile store 205 and retrieves prior purchases by other users having at least a threshold amount (e.g., a threshold number, a threshold percentage) of characteristics matching characteristics of the user. From prior purchases of the product when offered at different prices and characteristics of the user and other users who purchased the product, the price determination module 220 determines likelihoods of the user purchasing the product when offered at different prices.

In various embodiments, the price determination module 220 applies a trained machine learned model to a product and to characteristics of the user, along with a price, to determine a likelihood of the user purchasing the product when offered at the price. The price determination module 220 trains the machine learning model from prices at which products were previously purchased by the merchant system 130 and characteristics of users who previously purchased the products via the merchant system 130 and may account for other types of interactions by the users with the merchant system 130.

The price determination module 220 trains the machine learning model to determine a likelihood of a user purchasing a product when the product is offered at a particular price. For example, the price determination module 220 applies a label indicating a product was previously purchased from the merchant system 130 to a price of the product, to characteristics of users who purchased the product, and to characteristics of the product. From the labeled price, characteristics of the user, and characteristics of the product, the price determination module 220 trains the machine learning model using any suitable training method or combination of training methods (e.g., back propagation to train the machine learning model if it is a neural network, curve fitting techniques if the identification model is a linear regression). After training, the price determination module 220 applies the trained machine learning model to characteristics of a product, to characteristics of a user, and to a price of the product and the machine learning model outputs a probability of the user purchasing the product at the price.

In some embodiments, the pricing server 140 maintains a separate interaction store that identifies interactions by users with the merchant system 130. For example, the interaction store includes a description of an interaction by a user with the merchant system 130 in association with an identifier of the user and an identifier of the merchant system 130. A description of an interaction includes a type of the interaction and a date and a time when the interaction occurred in various embodiments. Example interactions include: selecting a prompt identifying alternative pricing for one or more products offered by the merchant system 130, presentation of the prompt identifying alternative pricing for one or more products offered by the merchant system 130 by the merchant system 130, requesting information from the merchant system 130, contacting the merchant system 130, selecting a product offered by the merchant system 130, selecting a description of a product offered by the merchant system 130, accessing reviews of a product offered by the merchant system 130, or any other suitable action involving the user (e.g., an interaction performed by the user, an interaction performed by the merchant system 130 with the user).

In various embodiments, the price determination module 220 retrieves features of a product from the purchase database 210 and determines purchases of other products by the user, as well as other users having the threshold amount of characteristics matching characteristics of the user. The price determination module 220 determines likelihoods of the user purchasing a product based on ratios of numbers of times the user and the other users purchased products having a threshold amount (e.g., a threshold number, a threshold amount) of features matching features of the product to numbers of times the merchant system 130 was visited or accessed when the products having the threshold amount of features matching features of the product were available for purchase. This allows the price determination module 220 to leverage purchases of products having at least a threshold similarity to the product by the user and by other users having a threshold similarity to the user to determine likelihoods of the user purchasing the product when offered at different prices. Hence, the price determination module 220 determines likelihoods of the user purchasing a product for different prices for the product.

From the likelihoods of the user purchasing a product at different prices, the price determination module 220 generates a user-specific price for one or more products. In one embodiment, the price determination module 220 generates a user-specific price for a product as a price having a maximum corresponding likelihood of the user purchasing the product. Alternatively, the price determination module 220 generates a user specific price for a product based on probabilities of the user purchasing the product for different prices and profit to the merchant system 130 for selling the product at different prices. In one embodiment, for each of a set of prices of the product, the price determination module determines a difference between a price of the product and a cost of the merchant system 130 to obtain the product (e.g., a wholesale price of the product for the merchant system 130 and costs incurred by the merchant system 130 to store and to physically obtain the product) then determines a product of a likelihood of the user purchasing the product offered at the price and the difference between the price of the product and the cost of the merchant system 130 to obtain the product (e.g., a wholesale price of the product for the merchant system 130 and costs incurred by the merchant system 130 to store and to physically obtain the product). The product of the difference between the price of the product and the cost of the merchant system 130 to obtain the product (e.g., a wholesale price of the product for the merchant system 130 and costs incurred by the merchant system 130 to store and to physically obtain the product) and the likelihood of the user purchasing the product at the price is an expected profit to the merchant system 130 for the price. The price determination module 220 generates a user-specific price for the product as a price having a maximum expected profit to the merchant system 130.

In various embodiments, the price determination module 220 determines user-specific prices for multiple products offered by the merchant system 130, as further described above, and orders the multiple products based on expected profits to the merchant system 130 for offering different products at the user-specific prices. For example, the price determination module 220 orders a set of products for which user-specific prices were generated so products having user-specific prices resulting in higher expected profits to the merchant system 130 have higher positions in the order. The price determination module 220 communicates the ordering of products along with their corresponding user-specific prices to the merchant system 130, which subsequently displays the products in the order determined by the price determination module 220. In various embodiments, the price determination module 220 transmits instructions to the merchant system 130 describing relative positioning of images corresponding to products in the determined order; however, the price determination module 220 may transmit instructions to the merchant system 130 describing relative positioning of any suitable information describing the products so information describing the products is displayed in an interface in the order determined by the price determination module 220. This allows the merchant system 130 to rearrange presentation of information describing different products based on the expected profit to the merchant system 130 from different products offered for sale with the user-specific prices generated by the price determination module 220.

The web server 225 links the pricing server 140 via the network 120 to the one or more client devices 110, as well as to the merchant system 130. The web server 225 serves web pages, as well as other content, such as JAVA®, FLASH®, XML and so forth. The web server 225 may receive and route messages between the pricing server 140 and the merchant system 130, for example, instant messages, queued messages (e.g., email), text messages, short message service (SMS) messages, or messages sent using any other suitable messaging technique. The merchant system 130 may send a request to the web server 225 to upload information (e.g., information describing products, information describing purchases of products) that are stored in the purchase database 210. Additionally, the web server 225 may provide application programming interface (API) functionality to send data directly to native client device operating systems, such as IOS®, ANDROID™, or BlackberryOS.

### Presenting Products Based on User-Specific Prices Generated for the Products

FIG. 3 is an interaction diagram of one embodiment of a method for determining an order in which a merchant system 130 presents products to a user based on user-specific prices determined for the user. The method may include different or additional steps than those described in conjunction with FIG. 3 in various embodiments. Further, the steps of the method may be performed in different orders than the order described in conjunction with FIG. 3 in various embodiments.

The merchant system 130 maintains 305 product information for products offered by the merchant system 130 for purchase by users. For example, each product offered by the merchant system 130 is associated with a unique product identifier, and the merchant system 130 maintains information about each product in association with the product's unique product identifier. Example information associated with a product includes a name of the product, a description of the product, a category of the product, ratings or reviews of the product received from users, a quantity of the product available for purchase via the merchant system 130, a quantity of the product available for purchase via the merchant system 130 (or an indication that the product is available for purchase via the merchant system 130), and text, audio, video, or images presented by the merchant system 130 to identify the product. Additionally, the online system 130 maintains a cost of the merchant system 130 to obtain the product (e.g., a wholesale price of the product for the merchant system 130 and costs incurred by the merchant system 130 to store and to physically obtain the product).

The merchant system 130 transmits 310 the product information for various products to a pricing server 140, further described above in conjunction with FIG. 2, via a network 120. For example, the merchant system 130 transmits 310 product information for each product offered by the merchant system 130 to the pricing server 140. As another example, the merchant system 130 transmits 310 product information for a subset of products offered by the merchant system 310 to the pricing server 140.

From the product information received from the merchant system 130, the pricing server 140 determines general prices for different products offered by the merchant system 130 and transmits 315 the general prices to the merchant system 130. In various embodiments, the merchant system 130 determines a general price of a product from a cost of the merchant system 130 to obtain the product (e.g., a wholesale price of the product for the merchant system 130 and costs incurred by the merchant system 130 to store and to physically obtain the product) and application of one or more trained models to the cost of the merchant system 130 to obtain the product that determine a general price for the product that maximizes a profit to the merchant system 130 when the product is purchased; an example of the merchant system 130 determining a general price for a product is further described above in conjunction with FIG. 1. In various embodiments, the pricing server 140 determines general prices for multiple products offered by the merchant system 140 and stores the general prices for retrieval and transmission 315 to the merchant system 140.

When a user initially accesses the merchant system 130, in some embodiments, the merchant system 130 identifies one or more products offered by the merchant system 130 to the user along with the general prices determines for the identified products. For example, the user accesses the merchant system 130 via a client device 110, and the merchant system 130 transmits a web page to the client device 110 including information describing different products offered by the merchant system 130 and corresponding general prices for the products included in the web page in different locations of the web page when presented by the client device 110. The web page the client device 110 receives from the merchant system 130 includes a prompt for the user to provide user identifying information to the merchant system 130. For example, the web page includes one or more input boxes or other user interface elements for the user to specify a username and password, or other user identifying information, via the client device 110. User identifying information received by the client device 110 is transmitted 320 to the merchant system 130, which identifies stored information associated with the user identifying information.

Receiving user identifying information from the client device 110 allows the merchant system 140 to obtain user-specific prices for various products offered by the merchant system 130 from the pricing server 140. As further described above in conjunction with FIG. 2, the pricing server 140 maintains user profiles for various users of the merchant system 130 that include characteristics of the user (e.g., a location of the user, an age of the user, a sex of the user, etc.). Additionally, the pricing server 140 maintains information describing historical purchases of products by various users via the merchant system 130 as well as information describing prior accesses of or visits to the merchant system 130 by various users, as further described above in conjunction with FIG. 2. In various embodiments, the merchant system 130 transmits information stored by the merchant system 130 describing prior accesses of or visits to the merchant system by various users, as well as historical purchases of products by users via the merchant system 130, to the pricing server 140. The merchant system 130 transmits 325 a request for user-specific prices that includes the user identifying information of the user received from the client device 110 to the pricing server 140. Hence, the request includes an identifier of the merchant system 130 as well as user identifying information received by the merchant system 130.

In response to receiving the request from the merchant system 130, the pricing server 140 obtains 330 historical purchase information for the merchant system 130 stored by the pricing server 140. As further described above in conjunction with FIG. 2, the pricing server 140 stores a number of times the merchant system 130 has been visited or has been accessed by users during a time interval, as well as a number of times different products have been purchased via the merchant system 130. In various embodiments, the information stored by the pricing server 140 describing prior purchases of products via the merchant system 130 identifies products offered by the merchant system 130 during different times, or during different accesses of or visits to the merchant system 130, allowing the information describing historical purchases to account for variations in products offered by the merchant system 130 at different times. The information describing historical purchases of products identifies a price of a product that was purchased via the online system 140. The pricing server 140 retrieves stored information describing historical purchase information associated with an identifier of the merchant system 130 included in the request.

Additionally, the pricing server 140 retrieves 335 characteristics of the user from a user profile maintained by the pricing server 130 for the user. The pricing server 140 retrieves a user profile corresponding to the information identifying the user included in the received request and retrieves 335 one or more characteristics of the user (e.g., the user's location, the user's age, the user's sex, etc.) from the retrieved user profile. The pricing server 140 retrieves 335 any suitable characteristics of the user or combination of characteristics of the user in various embodiments. In various embodiments, the pricing server 140 also retrieves 335 interactions by the user with the merchant system 130 (or by the merchant system 130 with the user) received from the merchant system 130 and stored by the pricing server 140, as further described above in conjunction with FIG. 2, The pricing server 140 receives information describing interactions by the user with the merchant system 130 or by the merchant system 130 with the user, which the pricing server 140 stores in association with an identifier of the user and with an identifier of the merchant system 130. From the identifier of the user identifying the user profile, the pricing server 140 also retrieves 335 interactions associated with the identifier of the user and associated with the identifier of the merchant system 130. In some embodiments, the pricing server 140 retrieves 335 interactions associated with the identifier of the user and associated with the identifier of the merchant system 130 satisfying one or more criteria (e.g., interactions occurring within a specific time interval).

From the historical purchase information for the merchant system 130 and one or more characteristics of the user, including interactions associated with the user, the pricing server 140 generates 340 user-specific prices for each of a set of products offered by the merchant system 130. As further described above in conjunction with FIG. 2, the pricing server 140 determines likelihoods of a product being purchased when offered at each of a plurality of prices from the historical purchase information stored by the pricing server 140. For example, the pricing server 140 determines a ratio of a number of times the product was purchased when offered at a price to a number of times users visited or accessed the merchant system 130 when the product was offered at the price (and available for purchase via the merchant system 130, in some embodiments) and modifies the determined ratio based on retrieved characteristics of the user. When determining the ratio of the number of times the product was purchased when offered at the price to the number of times users visited or accessed the merchant system 130 when the product was offered at the price, the pricing server 130 accounts for user interaction with the merchant system 130 to determine whether a user viewed a description of the product when accessing the merchant system 130. For example, from stored interactions by the user with the merchant system 130, the pricing server determines a ratio of a number of times the product was purchased when offered at the price to the number of times the users visited or accessed the merchant system 130 when the product was offered at the price and the user viewed a description or a price of the product via the merchant system 130. This allows the pricing server 140 to more particularly account for the user's exposure to the price of the product via the merchant system 130. In some embodiments, the pricing server 140 also identifies other users having at least a threshold amount (e.g., a threshold number, a threshold percentage) of characteristics matching the retrieved characteristics of the user and determines products purchased through the merchant system 130 by the other users. From products purchased by the other users and prices of the products purchased by the other users, the pricing server 140 modifies one or more of the determined ratios to determine likelihoods of the user purchasing the product at different prices. For each product of a set, the pricing server 140 determines a distribution of likelihoods of the user purchasing a product when offered at different prices.

In various embodiments, the pricing server 140 retrieves features of a product from corresponding product information received from the merchant system 130 and determines purchases of other products having at least a threshold amount of features matching features of the product by the user, as well as by other users having the threshold amount of characteristics matching characteristics of the user. The pricing server 140 determines likelihoods of the user purchasing a product based on ratios of numbers of times the user and the other users purchased products having the threshold amount (e.g., a threshold number, a threshold amount) of features matching features of the product to numbers of times the merchant system 130 was visited or accessed when the products having the threshold amount of features matching features of the product were available for purchase. As further described above, the pricing server 140 determines a distribution of likelihoods of the user purchasing a product when offered at different prices and determines the distribution of likelihoods for multiple products.

From the likelihoods of the user purchasing a product at different prices, the pricing server 140 generates 340 a user-specific price for one or more products. In various embodiments, for multiple prices for a product, the pricing server determines a difference between a price and a cost of the merchant system 130 to obtain the product (i.e., a wholesale price of the product for the merchant system 130 and costs incurred by the merchant system 130 to store and to physically obtain the product) and multiplies the determined difference by a likelihood of the user purchasing the product when offered at the price; hence, the pricing server 140 determines an expected amount of profit to the merchant system 130 for the price. The merchant system 140 determines the expected amount of profit to the merchant system 130 for multiple prices for the product and generates 340 the user-specific price for the product as a price having a maximum expected profit for the merchant system 130. This allows the pricing server 140 to leverage both prior purchases of products by users and characteristics of the user, as well as cost to the merchant system to obtain a product, to determine a user-specific price for the product that increases the user's likelihood of purchasing the product while increasing profit to the merchant system 130 when the product is sold. In various embodiments, the pricing server 140 adjusts the user-specific price based on information about the product obtained from the merchant system 130. For example, the pricing server 140 reduces the user-specific price if a price when the user-specific price was determined is within a threshold amount of time of an expiration date of the product to further increase a likelihood of the user purchasing the product. As another example, the pricing server 140 accounts for a quantity of the product that is available for purchase when the user-specific price was determined and adjusts the user-specific price (e.g., the user-specific price may be increased if there is less than a threshold amount of the product available for purchase, decreased if there is greater than an alternative threshold amount of the product available for purchase, decreased if there is less than the threshold amount of the product available for purchase, increased if there is greater than an alternative threshold amount of the product available for purchase, etc.).

From user-specific prices determined for each product of a set, the pricing server 140 orders 345 the products of the set. For example, the pricing server 140 orders 345 products of the set so products having user-specific prices resulting in higher expected profits to the merchant system 140 have higher positions in the order. In another example, the pricing server 140 determines expected profit changes for each product of the set, where an expected profit increase for a product is a difference between an expected profit for a product offered at its user-specific price and an expected profit for the product offered at its generalized price. The pricing server 140 orders 345 the products of the set so products having larger expected profit changes have higher positions in the order.

The pricing server 140 transmits 350 the determined order of the set of products and the user-specific prices for each product of the set to the merchant system 130 via the network 120. In some embodiments, the pricing server 140 transmits 350 instructions to the merchant system 130 for ordering display of images of products of the set relative to each other in an interface displayed by a client device 110 (e.g., in an interface displayed by an application executing on the client device 110) along with corresponding user-specific prices for each product of the set. The merchant system 130 subsequently transmits 355 descriptions of various products of the set, the order of the set of products, and the user-specific prices for products of the set to the client device 110 via the network 120. Subsequently, the client device 110 displays 360 descriptions of products in the set in the order determined by the pricing server 140 so a product description is displayed in conjunction with the corresponding user-specific price for the product. Hence, the merchant system 130 reorders the descriptions of products of the set based on the order received from the pricing sever 140, which repositions the relative order in which descriptions of products and their corresponding user-specific prices are presented. As the user-specific prices account for likelihoods of the user purchasing products of the set based on prior purchases of products, as well as user-specific characteristics, the order determined by the pricing server 140 repositions descriptions of products relative to each other in an interface based on likelihoods of the user purchasing various products determined from prior purchases of different products via the merchant system 130 over time so descriptions of products more likely to be purchased by the user are more readily accessible when the user accesses the merchant system 130. In some embodiments, the reordered descriptions of products are displayed in an interface within a web browser or another application associated with the merchant system 130 executing on a client device 110. Alternatively, the reordered descriptions of products are included in an email, text message, or other message generated by the merchant system 130 and transmitted to a client device 110 for presentation to the user.

This allows the merchant system 130 to more efficiently use a display area of a client device 110 so descriptions (e.g., images) of products that the user is more likely to purchase when offered at a corresponding user-specific price are more visible to the user. When the user accesses the merchant system 130 via a client device 110 having a limited display size, such as a mobile device, the merchant system 130 reordering descriptions of products based on the information from the pricing server allows the merchant system 130 to automatically reposition descriptions of products so the products that the user is most likely to purchase when offered at corresponding user-specific prices are presented before descriptions of other products in the limited display size of the client device 110. As the pricing server 140 determines likelihoods of the user purchasing products offered at user-specific prices based on prior interactions with descriptions of the products by various users via the merchant system 130, the repositioning of descriptions of products based on the pricing server 140 is based on prior interactions by users with the merchant system 130 allows the merchant system 130 to provide an improved interface identifying different products that accounts for a user's likelihood of purchasing the different products.

In various embodiments, the merchant system 130 accounts for other information when repositioning descriptions of products presented to the user. For example, the merchant system 130 uses the order determined by the pricing server 140, as well as additional criteria or models applied by the merchant system 130, so the merchant system 130 reorders the descriptions of products transmitted 355 to the client device 110 based on the order determined by the pricing server 140 and other criteria. The reordered descriptions of products are transmitted 355 from the merchant system 130 to the client device 110 along with corresponding user-specific prices for the products generated 340 by the pricing server 140. In other embodiments, the merchant system 130 reorders descriptions of a subset of products based on the user-specific prices for products of the set and an order of products of the subset received from the pricing server 140. For example, the merchant system 130 reorders product descriptions of products associated with a specific category based on the order of products associated with the specific category received from the pricing server 140.

While FIGS. 2 and 3 describe an embodiment where the pricing server 140 generates pricing information for products and transmits the pricing information to the merchant system 130, in alternative embodiments, the merchant system 130 includes the previously described functionality of the pricing server 140. For example, the merchant system 130 includes the user profile store 205, the purchase database 210, the interaction store 215, and the price determination module 220 further described above in conjunction with FIG. 2. This embodiment allows the merchant server 130 to locally determine general prices and user-specific prices for products, as further described in conjunction with FIG. 3, using information stored by the merchant system 130, allowing the merchant system 130 to include the functionality of the pricing server 140 further described above.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a pricing server, information from a merchant system identifying products offered for purchase by a merchant system;
determining, by the pricing server, a general price for each product for which the merchant system received information from the pricing server, the general price for a product determined by the pricing server applying a trained model to a cost of the merchant system to obtain the product;
receiving, at the pricing server, information from the merchant system describing prior purchases of products by users via the merchant system and describing prior accesses of the merchant system by users;
receiving a request for user-specific prices at the pricing server from the merchant system including information identifying a specific user that the merchant system received from a client device and identifying the merchant system;
obtaining, by the pricing server, information describing prior purchases of products by users via the merchant system;
retrieving, by the pricing server, characteristics of the specific user from the information identifying the specific user;
generating, by the pricing server, user-specific prices for each of a set of the products offered for purchase by the merchant system by applying one or more trained machine learning models to the characteristics of the specific user and information describing prior purchases of the products of the set by other users of the merchant system, a user-specific price for a product of the set based on a likelihood of the specific user purchasing the product of the set when offered at the user-specific price;
generating, by the pricing server, an order of the products of the set based on the user-specific prices for each product of the set; and
transmitting the determined order of the set of products and the user-specific prices for each product of the set to the merchant system for display to the specific user.

2. The method of claim 1, wherein the user-specific price for a product of the set corresponds to a price of the product of the set having a maximum expected profit to the merchant system, the expected profit of the product of the set comprising a product of a likelihood of the specific user purchasing the product of the set and a difference between the price of the product of the set and a cost of the merchant system to obtain the product of the set.

3. The method of claim 2, wherein generating, by the pricing server, the order of the products of the set based on the user-specific prices for each product of the set comprises:
for each product of the set of products, determining a difference between an expected profit to the merchant system for offering the product of the set at the user-specific price for the product of the set and a profit to the merchant system for offering the product of the set at a general price determined for the product of the set; and
ordering the products of the set so products of the set having a greater difference between the expected profit to the merchant system for offering the product of the set at the user-specific price for the product of the set and the profit to the merchant system for offering the product of the set at the general price determined for the product of the set have higher positions in the order.

4. The method of claim 1, wherein the information describing prior purchases of products by users identifies products offered by the merchant system during different times and prices at which one or more products were previously purchased from the merchant system.

5. The method of claim 1, wherein generating, by the pricing server, user-specific prices for each of a set of the products offered for purchase by the merchant system by applying one or more trained machine learning models to the characteristics of the specific user and information describing prior purchases of the products of the set by other users of the merchant system comprises:
determining likelihoods of the product of the set being purchased by the specific user when offered at each of a plurality of prices from a ratio of a number of times the product of the set was purchased when offered at a price to a number of times users accessed the merchant system when the product of the set was offered at the price and was available for purchase via the merchant system;
generating a distribution of likelihoods of the product of the set being purchased by the specific user when offered at different prices of the plurality of prices; and
selecting the user-specific price for the product of the set from the distribution.

6. The method of claim 5, wherein determining likelihoods of the product of the set being purchased by the specific user when offered at each of the plurality of prices from the ratio of a number of times the product of the set was purchased when offered at the price to the number of times users accessed the merchant system when the product of the set was offered at the price and was available for purchase via the merchant system comprises:
determining likelihoods of the product of the set being purchased by the specific user when offered at each of a plurality of prices from a ratio of a number of times the product of the set was purchased when offered at a price to a number of times users accessed the merchant system when the product was offered at the price, when the product was available for purchase via the merchant system, and when the specific user accessed a description of the product of the set via the merchant system.

7. The method of claim 5, wherein selecting the user-specific price for the product of the set from the distribution comprises:
determining an expected amount of profit to the merchant system for multiple prices of the product of the set for each of multiple prices of the plurality of prices, the expected amount of profit to the merchant system for a price comprising a product of a likelihood of the specific user purchasing the product of the set when offered at the price and a difference between the price and a cost of the merchant system to obtain the product of the set; and
selecting the user-specific price for the product as the price having a maximum expected amount of profit to the merchant system.

8. The method of claim 5, wherein the users who accessed the merchant system have at least a threshold amount of characteristics matching characteristics of the specific user.

9. The method of claim 1, wherein the one or more machine learning models comprise one or more neural networks.

10. The method of claim 1, wherein transmitting the determined order of the set of products and the user-specific prices for each product of the set to the merchant system for display to the specific user comprises:
transmitting instructions for ordering display of images of products of the set relative to each other in an interface displayed by the client device.

11. A method comprising:
receiving, at a pricing server, information from a merchant system identifying products offered for purchase by a merchant system;
receiving, at the pricing server, information from the merchant system describing prior purchases of products by users via the merchant system and describing prior accesses of the merchant system by users;
receiving a request for user-specific prices at the pricing server from the merchant system including information identifying a specific user that the merchant system received from a client device and identifying the merchant system;
obtaining, by the pricing server, information describing prior purchases of products by users via the merchant system;
retrieving, by the pricing server, characteristics of the specific user from the information identifying the specific user; and
generating, by the pricing server, user-specific prices for each of a set of the products offered for purchase by the merchant system by applying one or more trained machine learning models to the characteristics of the specific user and information describing prior purchases of the products of the set by other users of the merchant system, a user-specific price for a product of the set based on a likelihood of the specific user purchasing the product of the set when offered at the user-specific price.

12. The method of claim 11, wherein the user-specific price for a product of the set corresponds to a price of the product of the set having a maximum expected profit to the merchant system, the expected profit of the product of the set comprising a product of a likelihood of the specific user purchasing the product of the set and a difference between the price of the product of the set and a cost of the merchant system to obtain the product of the set.

13. The method of claim 11, further comprising:
generating, by the pricing server, an order of the products of the set based on the user-specific prices for each product of the set; and
transmitting the determined order of the set of products and the user-specific prices for each product of the set to the merchant system for display to the specific user

14. The method of claim 13, wherein transmitting the determined order of the set of products and the user-specific prices for each product of the set to the merchant system for display to the specific user comprises:
transmitting instructions for ordering display of images of products of the set relative to each other in an interface displayed by the client device.

15. The method of claim 13, wherein generating, by the pricing server, the order of the products of the set based on the user-specific prices for each product of the set comprises:
for each product of the set of products, determining a difference between an expected profit to the merchant system for offering the product of the set at the user-specific price for the product of the set and a profit to the merchant system for offering the product of the set at a general price based a cost of the merchant system to obtain the product of the set, the expected profit of the product of the set comprising a product of a likelihood of the specific user purchasing the product of the set and a difference between the price of the product of the set and a cost of the merchant system to obtain the product of the set; and
ordering the products of the set so products of the set having a greater difference between the expected profit to the merchant system for offering the product of the set at the user-specific price for the product of the set and the profit to the merchant system for offering the product of the set at the general price have higher positions in the order.

16. The method of claim 11, wherein the information describing prior purchases of products by users identifies products offered by the merchant system during different times and prices at which one or more products were previously purchased from the merchant system.

17. The method of claim 11, wherein generating, by the pricing server, user-specific prices for each of a set of the products offered for purchase by the merchant system by applying one or more trained machine learning models to the characteristics of the specific user and information describing prior purchases of the products of the set by other users of the merchant system comprises:
determining likelihoods of the product of the set being purchased by the specific user when offered at each of a plurality of prices from a ratio of a number of times the product of the set was purchased when offered at a price to a number of times users accessed the merchant system when the product of the set was offered at the price and was available for purchase via the merchant system;
generating a distribution of likelihoods of the product of the set being purchased by the specific user when offered at different prices of the plurality of prices; and
selecting the user-specific price for the product of the set from the distribution.

18. The method of claim 17, wherein determining likelihoods of the product of the set being purchased by the specific user when offered at each of the plurality of prices from the ratio of a number of times the product of the set was purchased when offered at the price to the number of times users accessed the merchant system when the product of the set was offered at the price and was available for purchase via the merchant system comprises:
determining likelihoods of the product of the set being purchased by the specific user when offered at each of a plurality of prices from a ratio of a number of times the product of the set was purchased when offered at a price to a number of times users accessed the merchant system when the product was offered at the price, when the product was available for purchase via the merchant system, and when the specific user accessed a description of the product of the set via the merchant system.

19. The method of claim 17, wherein selecting the user-specific price for the product of the set from the distribution comprises:
determining an expected amount of profit to the merchant system for multiple prices of the product of the set for each of multiple prices of the plurality of prices, the expected amount of profit to the merchant system for a price comprising a product of a likelihood of the specific user purchasing the product of the set when offered at the price and a difference between the price and a cost of the merchant system to obtain the product of the set; and
selecting the user-specific price for the product as the price having a maximum expected amount of profit to the merchant system.

20. The method of claim 11, wherein the one or more machine learning models comprise one or more neural networks.

21. A computer program product comprising a non-transitory computer readable storage medium having instructions encoded thereon that, when executed by a processor, cause the processor to:
receive, at a pricing server, information from a merchant system identifying products offered for purchase by a merchant system;
obtain, at the pricing server, information from the merchant system describing prior purchases of products by users via the merchant system and describing prior accesses of the merchant system by users;
receive a request for user-specific prices at the pricing server from the merchant system including information identifying a specific user that the merchant system received from a client device and identifying the merchant system;
retrieve, by the pricing server, information describing prior purchases of products by users via the merchant system;
retrieve, by the pricing server, characteristics of the specific user from the information identifying the specific user;
generate, by the pricing server, user-specific prices for each of a set of the products offered for purchase by the merchant system by applying one or more trained machine learning models to the characteristics of the specific user and information describing prior purchases of the products of the set by other users of the merchant system, a user-specific price for a product of the set based on a likelihood of the specific user purchasing the product of the set when offered at the user-specific price;
generate, by the pricing server, an order of the products of the set based on the user-specific prices for each product of the set; and
transmit the determined order of the set of products and the user-specific prices for each product of the set to the merchant system for display to the specific user.

22. The computer program product of claim 21, wherein the user-specific price for a product of the set corresponds to a price of the product of the set having a maximum expected profit to the merchant system, the expected profit of the product of the set comprising a product of a likelihood of the specific user purchasing the product of the set and a difference between the price of the product of the set and a cost of the merchant system to obtain the product of the set.

23. The computer program product of claim 21, wherein generate, by the pricing server, user-specific prices for each of a set of the products offered for purchase by the merchant system by applying one or more trained machine learning models to the characteristics of the specific user and information describing prior purchases of the products of the set by other users of the merchant system comprises:
determine likelihoods of the product of the set being purchased by the specific user when offered at each of a plurality of prices from a ratio of a number of times the product of the set was purchased when offered at a price to a number of times users accessed the merchant system when the product of the set was offered at the price and was available for purchase via the merchant system;
generate a distribution of likelihoods of the product of the set being purchased by the specific user when offered at different prices of the plurality of prices; and
select the user-specific price for the product of the set from the distribution.

24. The computer program product of claim 23, wherein determine likelihoods of the product of the set being purchased by the specific user when offered at each of the plurality of prices from the ratio of a number of times the product of the set was purchased when offered at the price to the number of times users accessed the merchant system when the product of the set was offered at the price and was available for purchase via the merchant system comprises:
determine likelihoods of the product of the set being purchased by the specific user when offered at each of a plurality of prices from a ratio of a number of times the product of the set was purchased when offered at a price to a number of times users accessed the merchant system when the product was offered at the price, when the product was available for purchase via the merchant system, and when the specific user accessed a description of the product of the set via the merchant system.

25. The computer program product of claim 23, wherein select the user-specific price for the product of the set from the distribution comprises:
determine an expected amount of profit to the merchant system for multiple prices of the product of the set for each of multiple prices of the plurality of prices, the expected amount of profit to the merchant system for a price comprising a product of a likelihood of the specific user purchasing the product of the set when offered at the price and a difference between the price and a cost of the merchant system to obtain the product of the set; and
select the user-specific price for the product as the price having a maximum expected amount of profit to the merchant system.
